(19) United States
(12) Patent Application Publication
(10) Pub. No.: US 2005/0278956 A1
(43) Pub. Date: Dec. 22, 2005

(54) Safety mechanism of a rotational tool

(75) Inventors: Renny Tse-Haw Ling, Chung-Ho City (TW); Ming Tsung Liu, Chung-Ho City (TW); Christian Bremicker, Wetter (DE)

Correspondence Address: BRUCE H. TROXELL, SUITE 1404, 5205 LEESBURG PIKE, FALLS CHURCH, VA, 22041, US

(73) Assignees: Sinox Co., Ltd; Aug. Bremicker Sohne KG

(21) Appl. No.: 10/952,822

(22) Filed: Sep. 30, 2004

(30) Foreign Application Priority Data
Jun. 17, 2004 (TW) 093117467

(51) Int. Cl. B26B 3/06

(52) U.S. Cl. 30/161

(57) ABSTRACT

A safety mechanism of a rotational tool includes at least a tool unit, a safety pivot with a long end part and a control device. The tool unit has a fixed shaft with a tail end. The safety pivot is disposed at the shaft with a perimeter having variable distance to the axis itself. The control device controls the safety pivot. The long end part of the safety pivot can resist the tail end of the tool unit from rotating during being disposed to face the fixed shaft.

### FIELD OF THE INVENTION

The present invention relates to a safety mechanism of a rotational tool and particularly to a safety mechanism with which a tool unit can be kept in a stare of being retracted in the main member during not in use so as to secure the tool unit being not turning out and exposing. The tool unit can be a knife, a screw driver, a grinding knife, a file or any other portable tools.

### BACKGROUND OF THE INVENTION

Rotational tools including cutters such as a knife with single rotational blade and a knife with multiple rotational blades are frequently used in our daily lives. Basically, the cutters or tools can expose after being turned outward while in use and can be turned inward received in slot spaces. Of course, there are probably multiple different cutters or tools piled together for the knife with multiple rotational blades.

Further, the preceding rotational tools are easy for being carry about and used due to being turned out and turned in so that it is the reason why they are kept selling in the market for years without fading away. However, there is deficiency that no safety mechanism is available.

It is known that there is a restriction to the user of a tool. Children should be not allowed to use the tool. Carelessness is unavoidable in our real lives but it is extremely unsafe in case of the tool being held by a child. For the multiple blade type knife, the blades are pretty sharp and it is not what we like to see if injuries are resulted from being without providing safety device for the tool.

### SUMMARY OF THE INVENTION

A main object of the present invention is to provide a safety mechanism of a rotational tool, which has a rotational safety pivot at the fixed shaft of a rotational tool unit with a long end part and a short end part with respect to the axis thereof, so that the long end part can resist the tail end of the tool unit from turning.

### BRIEF DESCRIPTION OF THE DRAWINGS

The present invention can be more fully understood by reference to the following description and accompanying drawings, in which:

FIG. 1 is a perspective view illustrating internal construct of a conventional rotation tool;

FIGS. 2a and 2b are plan views illustrating a preferred embodiment of a safety mechanism according to the present invention associated with the rotational tool and showing the rotational tool with the safety mechanism in a state of disengaging and in a state of engaging;

FIGS. 3a and 3b are plan views illustrating another preferred embodiment of a safety mechanism according to the present invention associated with the rotational tool and showing the rotational tool with the safety mechanism in a state of disengaging and in a state of engaging of a wrist rest for storing up a keyboard vertically in a first embodiment of the present invention;

FIG. 4 is a plan view illustrating a spring plate being added to embodiment shown in FIGS. 2a and 2b;

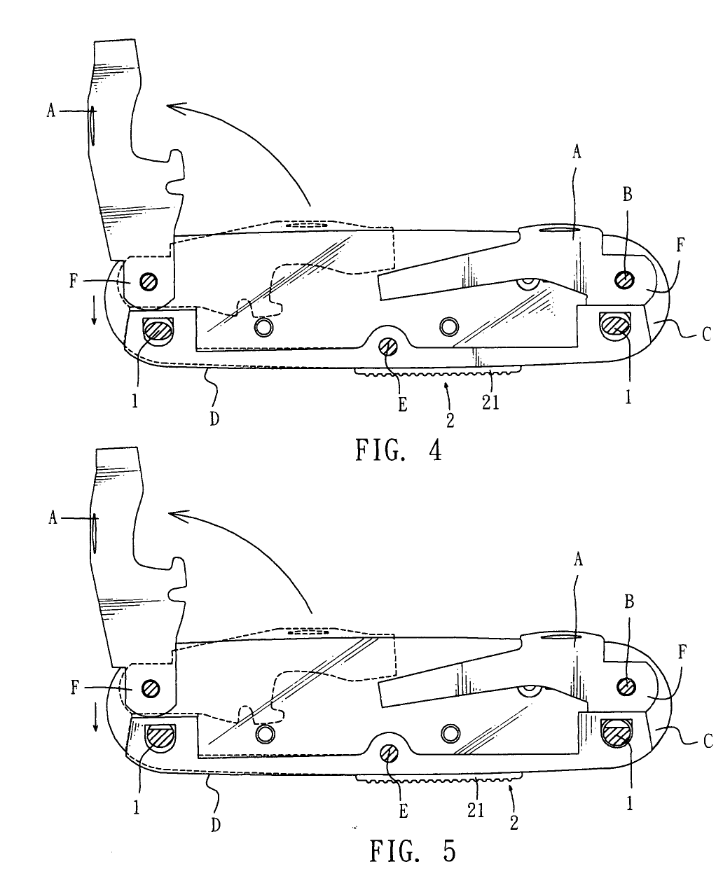

FIG. 5 is a plan view illustrating a spring plate being added to embodiment shown in FIGS. 3a and 3b;

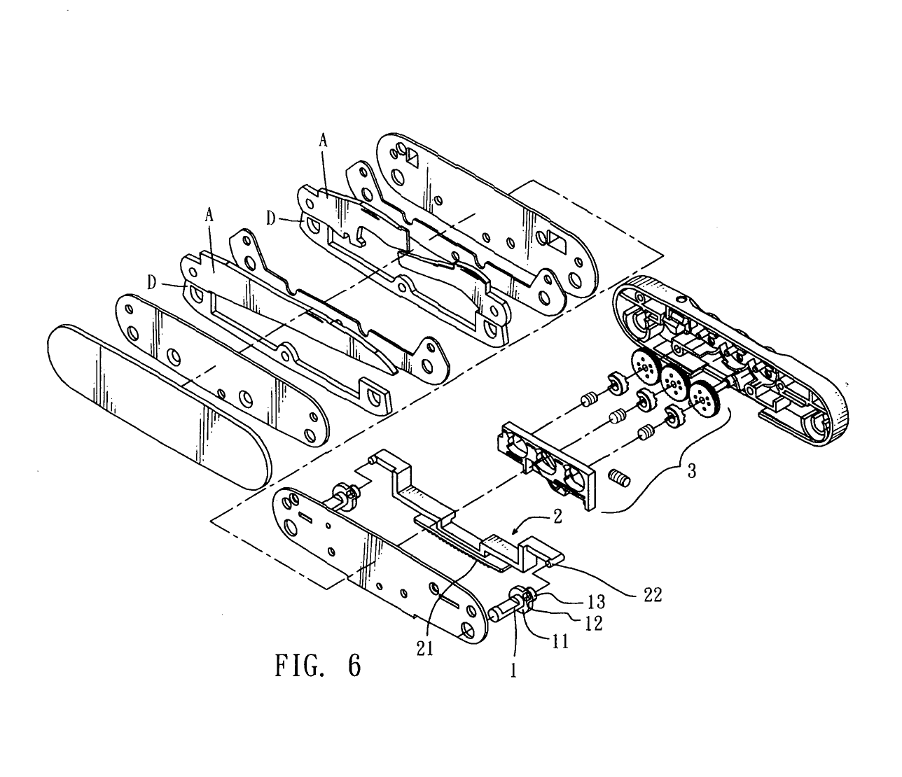

FIG. 6 is an exploded perspective view illustrating the preferred embodiment of the safety mechanism according to the present invention applied to the rotational tool;

FIG. 8 is a perspective view illustrating the safety mechanism in the preferred embodiment of the present invention being in a state of being alert; and

FIG. 9 is a perspective view illustrating the safety mechanism in the preferred embodiment of the present invention being in a state of being disarmed.

### DETAILED DESCRIPTION OF THE INVENTION

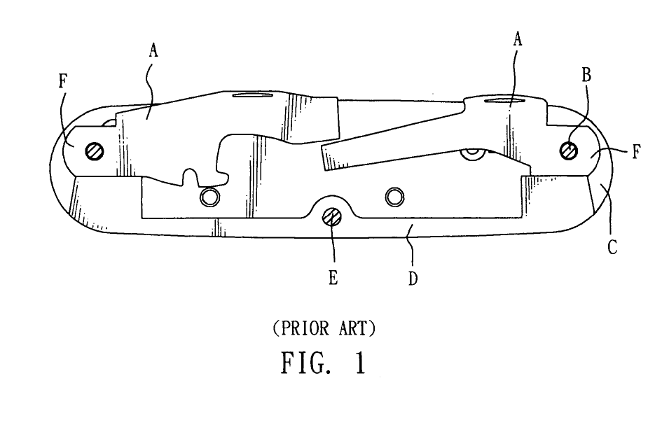

Referring to FIG. 1, two rotational tool units A are connected to a stationary shaft B pivotally respectively and the stationary shaft B is fixedly attached to the main member C of the rotational tool. One rotational tool A can be provided instead of two in case of the rotational tool A is longer. In order to obtain a feeling of differentiation between turning in or turning out, an elastic device can be added at a lateral side thereof such as a spring plate D. The spring plate D has a stationary fulcrum E, which can be pushed against or released from a tail end F of the tool unit A with variation of the perimeter thereof. When multiple sets of different rotational tools A are piled as multiple layers and each layer has the spring plate D, it can be understood that it can be perform to turn in and turn out by way of stirring the tool unit A. In this way, anybody including a child can operate under a condition of no safety mechanism.

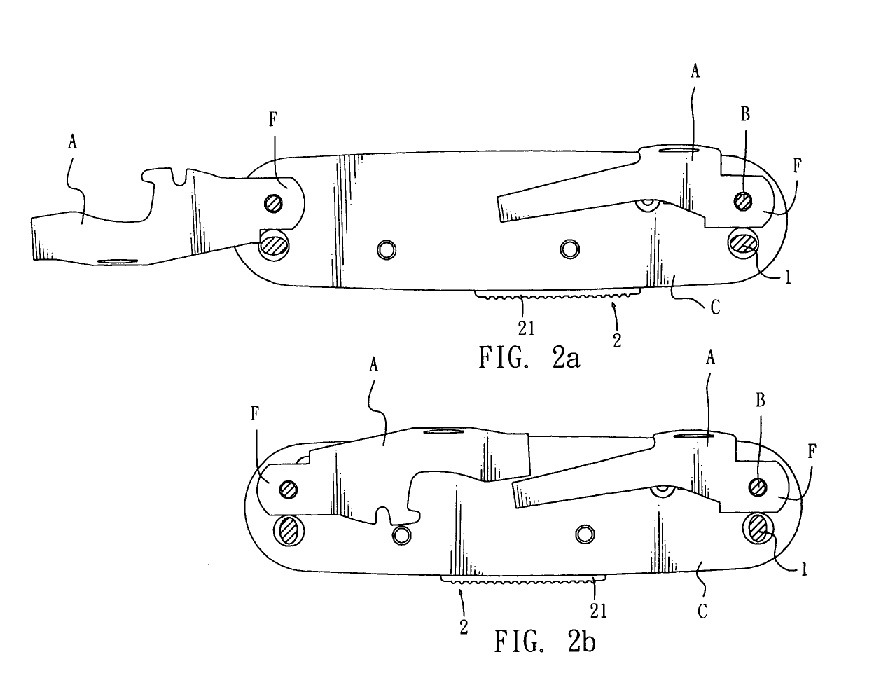

Referring to FIGS. 2a and 2b, in order to overcome the preceding deficiency, a safety pivot 1 of the present invention is provided at a lateral side opposite to the fixed shaft B to controllably rotate a certain angular displacement, which can be even 360 degrees, with a control device 2 for actuating the fixed shaft B. It is noted that the so-called tool unit A including the preceding tool unit but not limiting having the tool unit.

Wherein, the safety pivot 1 can rotate in the tool body C after being assembled and in order to be able to be contacted with and released from the fixed shaft B, the safety pivot 1 can be provided with an oval shaped post, that is, the short end part thereof can press against the tool unit A in case of the tool unit turning out and the long end part thereof can restrict the tool unit A moving during turning out so as to constitute an safety mechanism.

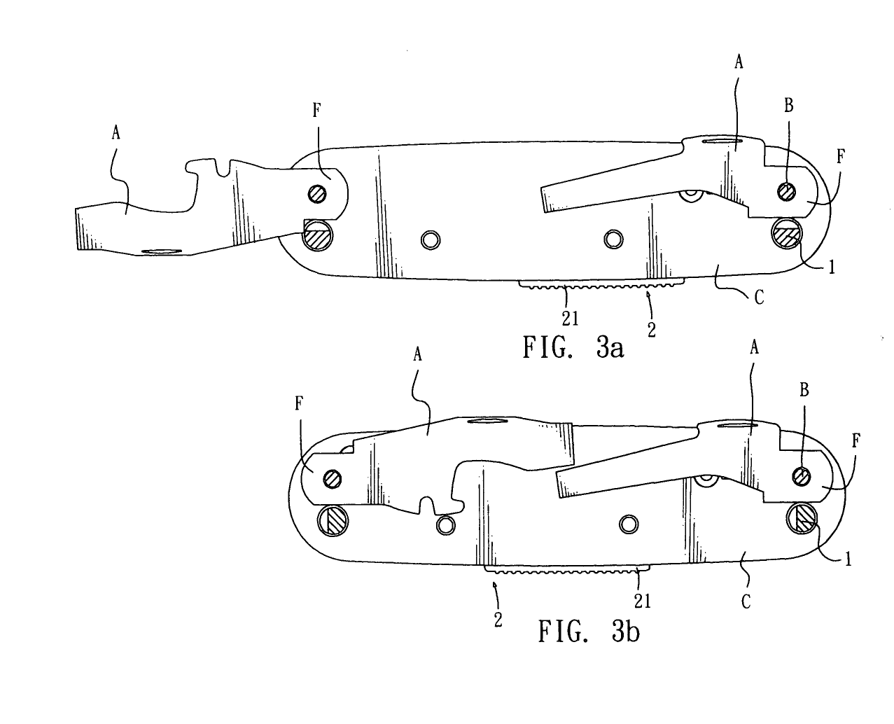

Nevertheless, referring to FIGS. 3a and 3b, the variable perimeter of the safety pivot 1 also can be performed by way of a specific thickness being cut off from the fixed shaft B to form a flat recess surface. Further, the preceding spring plate D can be inserted with the safety pivot 1 in addition to the tail end F of the tool unit A directly pressing against the safety pivot 1 such that the tail end F can press against the spring plate D to expand the spring plate D slightly outward while the tool unit A is turned and the spring plate D can restore original state while the tool unit A is retracted.

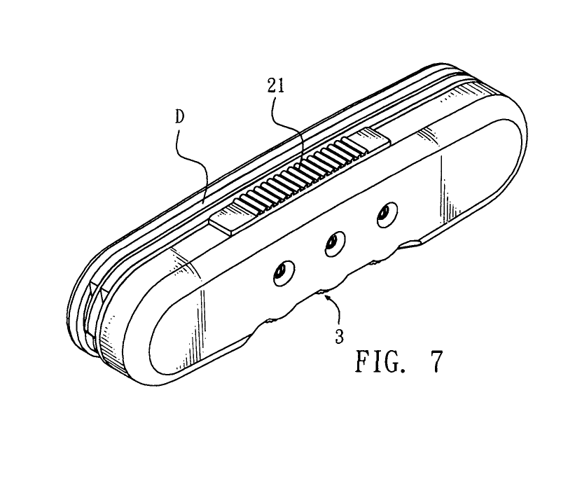

Besides, referring to FIGS. 6 and 7, the preceding control device 2, which can control the safety pivot 1 to rotate an angular displacement, includes a slidable base 21 with at least one of the two lateral sides thereof having an extending post 22. The safety pivot 1 is provided with a sleeve ring 11 and a fitting plate 13 with a fitting hole 12 extending from the sleeve ring 11 so as to fit with the post 22 of the slidable base 21. In the mean time, a lock tool 3 is adapted to the control device 2 and the slidable base 21 is incapable of moving once the lock 3 is locked up. Consequently, the tool unit A is unable to move too. The lock tool 3 in the preferred embodiment is combination lock but it is noted that the combination lock is only an example not a limitation. Further, the control device 2 can be a spring (not shown) surrounding the safety pivot 1 and it can be in a state of rotation in case of being pressed and can be in a state of unmoved in case of being released and expanding.

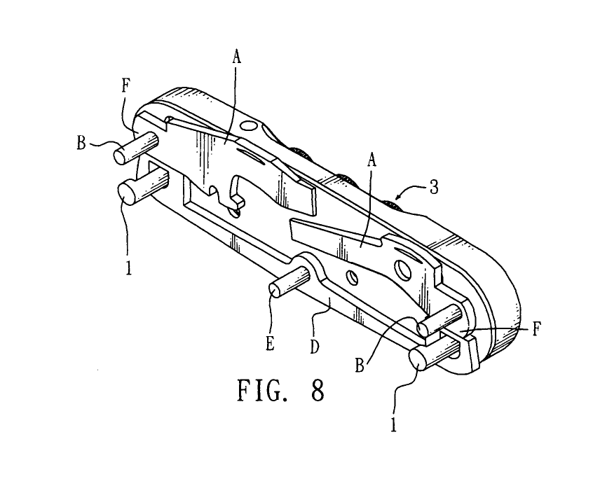

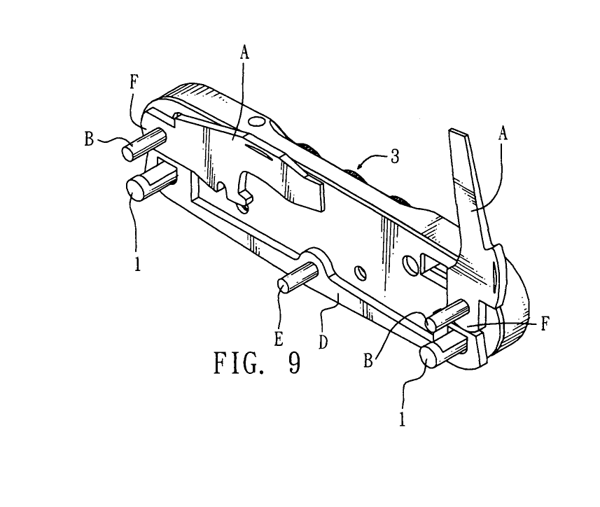

Referring to FIG. 8, although operation of turning in and turning out for the tool unit A is similar to the prior art, the safety pivot 1 with the long end part thereof toward the shaft B of the tool unit A via the control device 2 being actuated while the safety mechanism is started. Thus, the tail end F of the tool unit A is incapable of rotating due to being restricted with the long end part of the safety pivot 1, that is, the tool unit A is unable to be turned outward. While the safety mechanism is disarmed as shown in FIG. 9, the only thing has to be done is the short end part of the safety pivot 1 facing the shaft B of the tool unit A. In this way, it can restore the function of the tool unit A turning inward and turning outward.

It is has to mentioned here that the preceding explanation of the rotational tool according to the present invention can provide multiple piled tool units A commonly sharing a fixed shaft B or a single tool unit A.

While the invention has been described with reference to the a preferred embodiment thereof, it is to be understood that modifications or variations may be easily made without departing from the spirit of this invention, which is defined by the appended claims.

1. A safety mechanism of a rotational tool, comprising:
at least a tool unit, providing a fixed shaft with a tail end;
a safety pivot with a long end part, being provided at the shaft, having a perimeter with variable distance to the axis thereof; and
a control device, controlling the safety pivot;
whereby, the long end part of the safety pivot can resist the tail end of the tool unit from rotating during being disposed to face the fixed shaft.

2. The safety mechanism of a rotational tool as defined in claim 1, wherein the safety pivot is an oval post.

3. The safety mechanism of a rotational tool as defined in claim 1, wherein the safety pivot is a post like object with a recess surface corresponding to the shaft.

4. The safety mechanism of a rotational tool as defined in claim 1, wherein the control device is an elastic member capable of interfering the safety pivot and is arranged to surround the safety pivot.

5. The safety mechanism of a rotational tool as defined in claim 1, wherein the control device provides a slidable base with an extending post at least at a lateral side thereof and the safety pivot has a fitting ring with an extending fitting pate with a fitting hole so as to fit with the extending post.

6. The safety mechanism of a rotational tool as defined in claim 1, wherein the rotational tool has a plurality of tool units commonly share the shaft.

7. The safety mechanism of a rotational tool as defined in claim 1, wherein the rotational tool has the shaft at two ends of the main body thereof respectively and the safety mechanism is provided corresponding to the two ends respectively.

8. The safety mechanism of a rotational tool as defined in claim 1, wherein the rotational tool further comprises a cutter.

9. The safety mechanism of a rotational tool as defined in claim 1, wherein the spring plate can be attached to the safety mechanism to perform indirect contact.

10. The safety mechanism of a rotational tool as defined in claim 4, wherein the elastic member is a spring.

11. The safety mechanism of a rotational tool as defined in claim 1, wherein the slidable base is further provided with a lock tool to limit the displacement.

12. The safety mechanism of a rotational tool as defined in claim 1, wherein the lock tool is combination lock.
